(19) United States
(12) Patent Application Publication
(10) Pub. No.: US 2001/0040384 A1
(43) Pub. Date: Nov. 15, 2001

(54) High tech visor

(76) Inventors: Barbara Graham, Jersey City, NJ (US); Denits Graham, Jersey City, NJ (US); David Waters, Jersey City, NJ (US)

Correspondence Address: Matthew J. Peirce, Esq., 1550 Starlight Canyon Avenue, Las Vegas, NV, 89123, US

(21) Appl. No.: 09/849,381

(22) Filed: May 4, 2001

Related U.S. Application Data
(60) Provisional application No. 60/202,050, filed on May 5, 2000.

(51) Int. Cl. B60J 3/00

(52) U.S. Cl. 296/97.1; 296/97.6

(57) ABSTRACT

Several variations of a new and improved sun visor for use within a motor vehicle are disclosed, with the visors coming in different sizes to fit all types of vehicles, such as automobiles, vans, trucks, boats, trains, and planes. The variations would comprise three different types of visors. The first variation of visor would replace the standard sun visor that is located at the top of a standard windshield immediately above an operator's line of sight while operating a particular vehicle. The second variation of visor would serve as a “clamp on” visor which would be removably attached to a standard car visor that would be present in a vehicle. The third type of visor would be used to cover a side window of a particular vehicle. The third variation of visor would use either clamps to serve as a “clamp on” visor or alternatively would have a pair of suction cups to removably attach the third type of visor to a particular side window.

### BACKGROUND OF THE INVENTION

The present invention concerns that of a new and improved set of visors for use while operating a motorized vehicle, with the visors coming in different sizes to fit all types of vehicles, such as automobiles, vans, trucks, boats, trains, and planes.

### DESCRIPTION OF THE PRIOR ART

U.S. Pat. No. 5,523,877, issued to Lynam, discloses an ultraviolet protected, safety protected, reduced near-infrared radiation transmitting vehicular glazing assembly.

U.S. Pat. No. 5,247,391, issued to Gormley, discloses a glare shield for removably mounting on vehicle windows and other light-reflective surfaces to block the sunlight and reduce glare.

U.S. Pat. No. 4,892,394, issued to Bidabad, discloses an electronic sun shield which is an electronically operated grid that enables the operators of motor vehicles and other vehicles to control the shading of their windshield.

### SUMMARY OF THE INVENTION

The present invention concerns that of some new and improved variations of sun visors for use while operating a motorized vehicle, with the visors coming in different sizes to fit all types of vehicles, such as automobiles, vans, trucks, boats, trains, and planes. The variations would comprise three different types of visors. The first variation of visor would replace the standard sun visor that is located at the top of a standard windshield immediately above an operator's line of sight while operating a particular vehicle. The second variation of visor would serve as a “clamp on” visor which would be removably attached to a standard car visor that would be present in a vehicle. The third variation of visor would be used to cover a side window of a particular vehicle. The third variation of visor would use either clamps to serve as a “clamp on” visor or alternatively would have a pair of suction cups to removably attach the third type of visor to a particular side window.

There has thus been outlined, rather broadly, the more important features of some sun visors in order that the detailed description thereof that follows may be better understood and in order that the present contribution to the art may be better appreciated. There are, of course, additional features of the sun visors that will be described hereinafter and which will form the subject matter of the claims appended hereto.

In this respect, before explaining at least one embodiment of the sun visors in detail, it is to be understood that the sun visors are not limited in their application to the details of construction and to the arrangements of the components set forth in the following description or illustrated in the drawings. The sun visors are capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present sun visors. It is important, therefore, that the claims be regard as including such equivalent constructions insofar as they do not depart from the spirit and scope of the present invention.

It is therefore an object of the present invention to provide a sun visor which has all of the advantages of the prior art and none of the disadvantages.

It is another object of the present invention to provide a sun visor which may be easily and efficiently manufactured and marketed.

It is another object of the present invention to provide a sun visor which is of durable and reliable construction.

It is yet another object of the present invention to provide a sun visor which is economically affordable and available for relevant purchasing government entities.

Other objects, features and advantages of the present invention will become more readily apparent from the following detailed description of the preferred embodiment when considered with the attached drawings and appended claims.

### BRIEF DESCRIPTION OF THE DRAWINGS

FIG. 1 shows a perspective view of the first type of visor of the present invention.

FIG. 2 shows a perspective view of the second type of visor of the present invention.

FIG. 3 shows a perspective view of the third type of visor of the present invention.

### DESCRIPTION OF THE PREFERRED EMBODIMENT

FIG. 1 shows a perspective view of the first type of visor of the present invention, which is attached visor 2. Attached visor 2 has a width 4 and a length 6. Length 6 would be approximately six to eight inches longer than a standard visor that would be found in a vehicle. The extra length found in length 6 of attached visor 2 would provide better glare protection for an operator of whatever vehicle attached visor would be within.

Attached visor 2 would come in three sizes. First, attached visor 2 would come in a small size for small windshields. Next, attached visor 2 would also come in a medium size for medium size windshields. Finally, attached visor 2 would also come in a large size for large windshields.

Attached visor 2 would be fabricated from durable clear plastic that would change with outside light in a manner similar to that of some eyeglasses worn by people. If it would be bright or sunny out, attached visor 2 would change to a dark mode, while once it would become dark again outside, attached visor 2 would change back to a clear complexion. Attached visor 2 would be designed to replace a standard visor that would typically come with the vehicle.

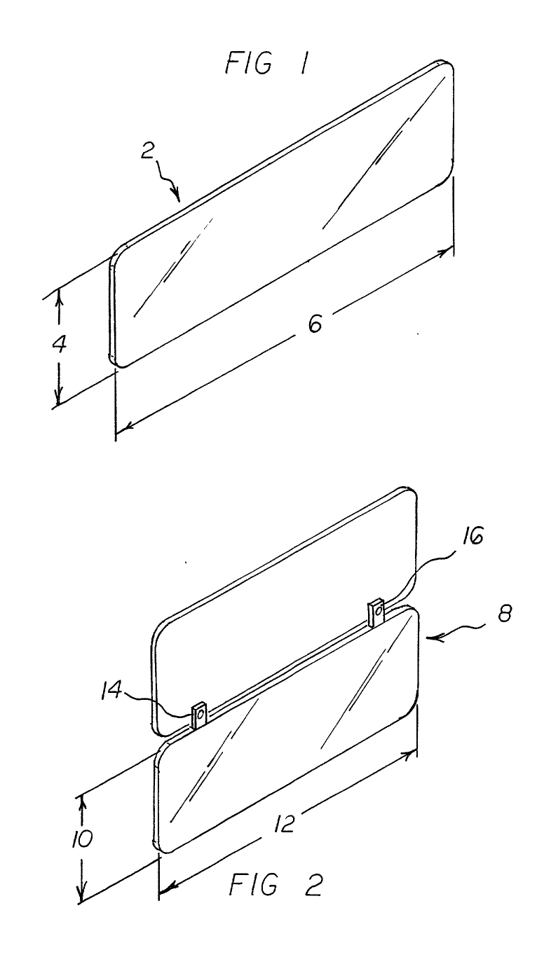

FIG. 2 shows a perspective view of the second type of visor of the present invention, which is clamp-on visor 8. Clamp-on visor 8 has a width 10 and a length 12. Length 12 would be approximately ten to fifteen inches longer than a standard visor that would be found in a vehicle.

Clamp-on visor 8 would come in three sizes. First, clamp-on visor 8 would come in a small size for small windshields. Next, clamp-on visor 8 would also come in a medium size for medium size windshields. Finally, clamp-on visor 8 would also come in a large size for large windshields.

Clamp-on visor 8 would come in two alternative embodiments. In the first alternative embodiment, clamp-on visor 8 would be always be opaque and would not change color or complexion when light conditions would change. In the second alternative embodiment, clamp-on visor 8 would be fabricated from durable clear plastic that would change with outside light in a manner similar to that of some eyeglasses worn by people. If it would be bright or sunny out, the second alternative embodiment of clamp-on visor 8 would change to a dark mode, while once it would become dark again outside, clamp-on visor 8 would change back to a clear complexion.

Clamp-on visor 8 would have two top-mounted clamps 14 and 16. With clamps 14 and 16, clamp-on visor 8 would serve as an “add-on” to an existing visor to provide extra and added protection from bright light sources.

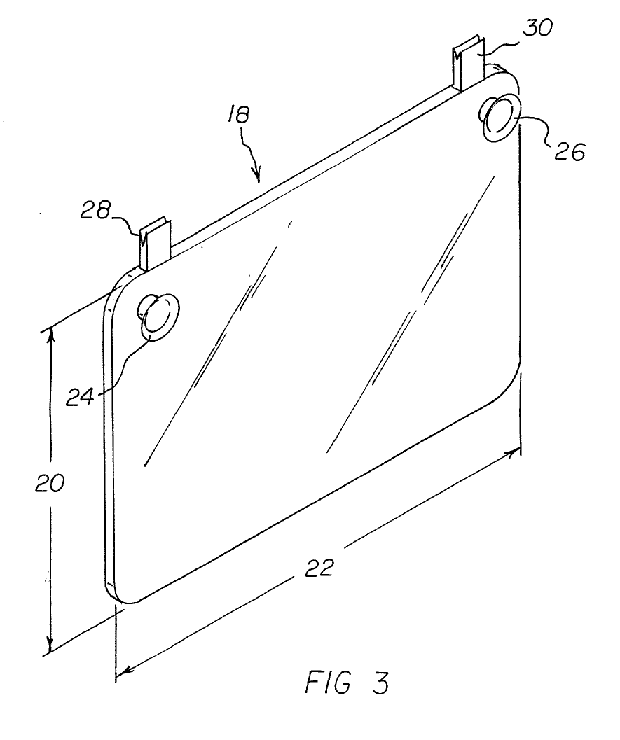

FIG. 3 shows a perspective view of the third type of visor of the present invention, which is side-window visor 18. Side-window visor 18 has a width 20 and a length 22. Side-window visor 18 would come in sets of two, and when placed on a side window, would cover the appropriate side window in length and leave two inches at the bottom of the side window.

Side-window visor 18 would come in three sizes. First, side-window visor 18 would come in a small size for small side windows. Next, side-window visor 18 would also come in a medium size for medium size side windows. Finally, side-window visor 18 would also come in a large size for large side windows.

Side-window visor 18 would come in two alternative embodiments. In the first alternative embodiment, side-window visor 18 would be always be opaque and would not change color or complexion when light conditions would change. In the second alternative embodiment, side-window visor 18 would be fabricated from durable clear plastic that would change with outside light in a manner similar to that of some eyeglasses worn by people. If it would be bright or sunny out, the second alternative embodiment of side-window visor 18 would change to a dark mode, while once it would become dark again outside, side-window visor 18 would change back to a clear complexion.

Side-window visor 18 would have two top-mounted clamps 28 and 30. With clamps 28 and 30, side-window visor 18 would serve as an “add-on” unit to an existing side window to provide extra and added protection from bright light sources. In an alternative embodiment, side-window visor 18 would include suction cups 24 and 26 in lieu of clamps 28 and 30.

What I claim as my invention is:

1. A front windshield visor having a length and a width, the front windshield visor being fabricated from a non-glass durable substance, the non-glass durable substance being clear when little or no light is present but becoming opaque due to shading when exposed to sunlight or bright light.

2. A front windshield visor according to claim 1 wherein the length of the front windshield visor is approximately six to eight inches longer than a standard windshield visor.

3. A front windshield visor according to claim 1 in combination with a vehicle, the vehicle including a front windshield, the front windshield having two surfaces, an inner surface and an outer surface, the front windshield having a top edge and a bottom edge, the front windshield visor being attached to the inner surface near the top edge of the front windshield.

4. A front windshield visor having a length and a width, the front windshield visor being fabricated from a non-glass durable substance, the front windshield having attachment means for attaching to a previously-installed front windshield visor within a vehicle.

5. A front windshield visor according to claim 4, wherein the attachment means for attaching to a previously-installed front windshield visor within a vehicle would comprise a pair of clamps, a first clamp and a second clamp, with both the first clamp and the second clamp designed to removably attach to a previously-installed front windshield visor within a vehicle.

6. A front windshield visor according to claim 5, wherein the non-glass durable substance would be clear when little or no light is present but would become opaque due to shading when exposed to sunlight or bright light.

7. A front windshield visor according to claim 5, wherein the non-glass durable substance would always be shaded.

8. A side-window sun visor having a length and a width, the side-window windshield visor being fabricated from a non-glass durable substance, the non-glass durable substance being clear when little or no light is present but becoming opaque due to shading when exposed to sunlight or bright light, the side-window sun visor having attachment means for attaching to a side window.

9. A side-window sun visor according to claim 8, wherein the width of the sun visor would be a few inches shorter than a side window.

10. A side-window sun visor according to claim 9, wherein the attachment means for attaching to a side window would comprise a pair of clamps, a first clamp and a second clamp, with both the first clamp and the second clamp designed to removably attach to a side window within a vehicle.

11. A side-window sun visor according to claim 9, wherein the attachment means for attaching to a side window would comprise a pair of suction cups, a first suction cup and a second suction cup, with both the first suction cup and the second suction cup designed to removably attach to the inside surface of a side window within a vehicle.
